(19) United States
(12) Patent Application Publication
(10) Pub. No.: US 2007/0122110 A1
(43) Pub. Date: May 31, 2007

(54) Receiver provided with electronic program guide

(75) Inventor: Tomo Kawahara, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/602,999

(22) Filed: Nov. 22, 2006

(30) Foreign Application Priority Data
Nov. 28, 2005 (JP) 2005-342499

(51) Int. Cl. H04N 5/91

(52) U.S. Cl. 386/83

(57) ABSTRACT

The present invention provides a receiver provided with an electronic program guide in a program configuration with other programs inserted in the middle thereof, which easily transmits a reservation excluding the programs inserted in the middle thereof. In step S180, programs closely related to a reserved program are extracted from the electronic program guide information stored in RAM 13, it is judged in next step S190 whether or not there are programs closely related to the reserved program before and after the reserved program, and if there are such programs, control moves to step S200 or moves to step S120 otherwise. In step S200, a screen is displayed which prompts a user to select whether or not to reserve the programs closely related to the reserved program.

The present application is based on and claims priority of Japanese patent application No. 2005-342499 filed on Nov. 28, 2005, the entire contents of which are hereby incorporated by reference.

### BACKGROUND OF THE INVENTION

1. Field of the Invention

The present invention relates to a receiver provided with an electronic program guide (EPG), and more particularly, to a television receiver which makes reservations of viewing using an electronic program guide, DVD decoder, HDD decoder, video cassette recorder or the like which makes reservations of recording.

2. Description of the Related Art

The electronic program guide (EPG) is designed to receive electronic program guide information on program names, broadcasting times, explanations of the programs (performers, outline of the program or the like) and display these items on the screen so as to facilitate selections, reservations of viewing, reservations of recording.

Japanese Patent Laid-Open Publication No. 2001-36846 (patent document 1) discloses a technology of making a series of reservations on a weekly or daily basis using an electronic program guide. More specifically, this technology regards programs that have the same program name, the same channel number or programs to be broadcast on the same day of the week or at the same time as a certain specified program as targets for a series of reservations. According to this technology, it is possible to set reservations for a program which is broadcast at a scheduled time every week or every day through a single reservation operation.

Japanese Patent Laid-Open Publication No. 11-187328 (patent document 2) discloses a technology of searching for a program including keywords entered by the user beforehand from electronic program guide information and reserving recording of a detected program automatically. According to this technology, once keywords are entered, it is possible to collectively reserve recording of a plurality of programs including the keywords.

In the case of a program with a long broadcasting time, another program may be inserted in the middle thereof. FIG. 4A shows an example where short news programs are inserted between quarters of an American football game being broadcast. In such a case, many users may want to watch all quarters but not the news programs inserted in the middle thereof. Especially, in the case of reserved recording, considering the amount of space of a recording medium used, it is preferable to avoid recording programs of no interest whenever possible.

Conventional reserved recording as shown in FIG. 4A requires reservation settings to be made a plurality of times so as to prevent news programs inserted in the middle from being recorded, which causes a problem of being quite troublesome. Since such broadcasting is not repeated every week or every day, using the technology disclosed in the patent document 1 cannot solve this problem. Furthermore, since there is a possibility that there may be different programs which contain the same keywords, even using the technology disclosed in the patent document 2 cannot solve this problem.

### SUMMARY OF THE INVENTION

The present invention has been implemented in view of the above described problems and it is an object of the present invention to provide a receiver provided with an electronic program guide which can easily make a reservation even when other programs are inserted in the middle by displaying programs closely related to an initially reserved program as reservation candidates and setting the reservation.

The receiver provided with an electronic program guide according to a first aspect of the present invention is a receiver provided with an electronic program guide, comprising an electronic program guide information receiving function of receiving electronic program guide information which has a program name, broadcasting time and program explanations, an inputting function of inputting reservation information which specifies a program to be reserved, a storage function of storing the electronic program guide information and reservation information, a video processing function of outputting a video signal and a control function of controlling the electronic program guide information receiving function, inputting function, storage function and video processing function, wherein the control function causes the video processing function to output the video signal of the electronic program guide information stored by the storage function, and causes, when the reservation information which specifies the program to be reserved is inputted by the inputting function, the storage function to store the reservation information, the control function searches, when the reservation information is inputted by the inputting function, programs closely related to the program to be reserved specified by the inputted reservation information from the electronic program guide information stored in the storage means, causes, when closely related programs are found within a range a predetermined number of programs before and after the program to be reserved specified with the inputted reservation information, the video processing function to output the video signal of the information which specifies the closely related programs and causes, when the reservation information which specifies the closely related programs is inputted by the inputting function, the storage function to store the reservation information of the closely related programs.

According to the receiver provided with an electronic program guide according to the first aspect of the present invention, programs closely related to the program to be reserved specified with the inputted reservation information are displayed automatically, and therefore it is possible to easily reserve these programs.

The receiver provided with an electronic program guide according to a second aspect of the present invention is the receiver provided with an electronic program guide according to the first aspect of the present invention, wherein programs having program explanations identical or similar to those of the program to be reserved specified with the inputted reservation information are defined as closely related programs.

According to the receiver provided with an electronic program guide according to the second aspect of the present invention, programs having program explanations identical or similar to those of the program to be reserved specified with the inputted reservation information are displayed automatically, and therefore it is possible to easily reserve these programs.

The receiver provided with an electronic program guide according to a third aspect of the present invention is the receiver provided with an electronic program guide according to the first aspect of the present invention, wherein programs having program names identical or similar to that of the program to be reserved specified with the inputted reservation information are defined as closely related programs.

According to the receiver provided with an electronic program guide according to the third aspect of the present invention, programs having program names identical or similar to that of the program to be reserved specified with the inputted reservation information are displayed automatically, and therefore it is possible to easily reserve these programs.

The receiver provided with an electronic program guide according to a fourth aspect of the present invention is the receiver provided with an electronic program guide according to the first aspect of the present invention, wherein programs having an identical transmitting broadcasting station of the programs having program names identical or similar to that of the program to be reserved specified with the inputted reservation information are defined as closely related programs.

According to the receiver provided with an electronic program guide according to the fourth aspect of the present invention, programs having an identical transmitting broadcasting station of the programs having program names identical or similar to that of the program to be reserved specified with the inputted reservation information are displayed automatically, and therefore it is possible to easily reserve these programs.

### BRIEF DESCRIPTION OF THE DRAWINGS

FIG. 1 is a block diagram showing the configuration of an embodiment;

FIG. 2 illustrates a remote controller of the embodiment;

FIG. 3 is a flow chart showing a processing flow of the embodiment;

FIGS. 4A and B illustrate a program table displayed by an electronic program guide and contents displayed on a screen in reservation settings of the embodiment; and

FIGS. 5A, B, and C illustrate contents displayed on the screen in reservation settings of the embodiment.

### DETAILED DESCRIPTION OF THE PREFERRED EMBODIMENTS

An embodiment of the present invention will be explained with reference to the attached drawings. It should be noted that the following embodiment is nothing more than a specific example of the present invention and the present invention is not limited to the following embodiment.

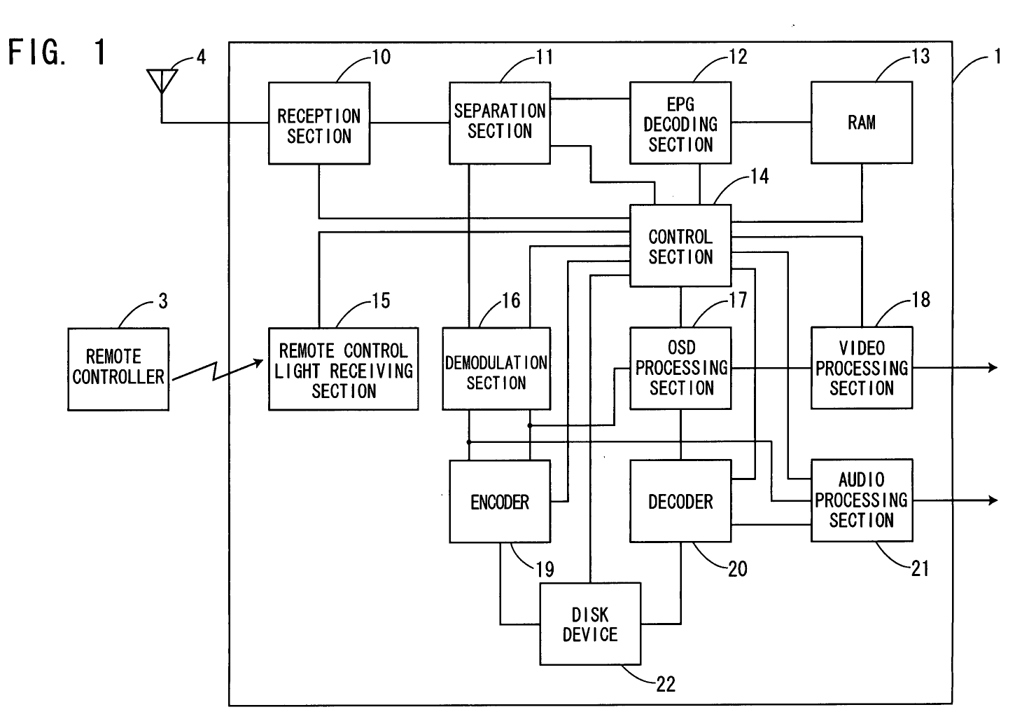

FIG. 1 is a block diagram showing the configuration of a receiver of this embodiment. A receiver 1 provided with an electronic program guide is provided with a reception section 10, a separation section 11, an EPG decoding section 12, a RAM 13, a control section 14, a remote control light receiving section 15, a demodulation section 16, an OSD processing section 17, a video processing section 18, an encoder 19, a decoder 20, an audio processing section 21 and a disk device 22.

The reception section 10 receives a signal from an antenna 4. The separation section 11 separates a signal including electronic program guide information from the signal received at the reception section 10. The EPG decoding section 12 decodes the electronic program guide information from the signal including the electronic program guide information separated at the reception section 10. The RAM 13 stores the electronic program guide information and the reservation information decoded at the EPG decoding section 12. The control section 14 controls the respective sections provided for the receiver 1. The remote control light receiving section 15 receives a control signal transmitted from the remote controller 3. The demodulation section 16 demodulates the received signal and outputs a video signal and an audio signal. The OSD processing section 17 performs OSD processing (when there is no need for the OSD processing, the inputted video signal is let pass as is). The video processing section 18 outputs the inputted video signal. The encoder 19 converts the video signal and the audio signal to data which can be recorded into the disk device 22. The decoder 20 converts the data recorded in the disk device 22 to a video signal and an audio signal. The audio processing section 21 outputs an audio signal. The disk device 22 records video and audio data.

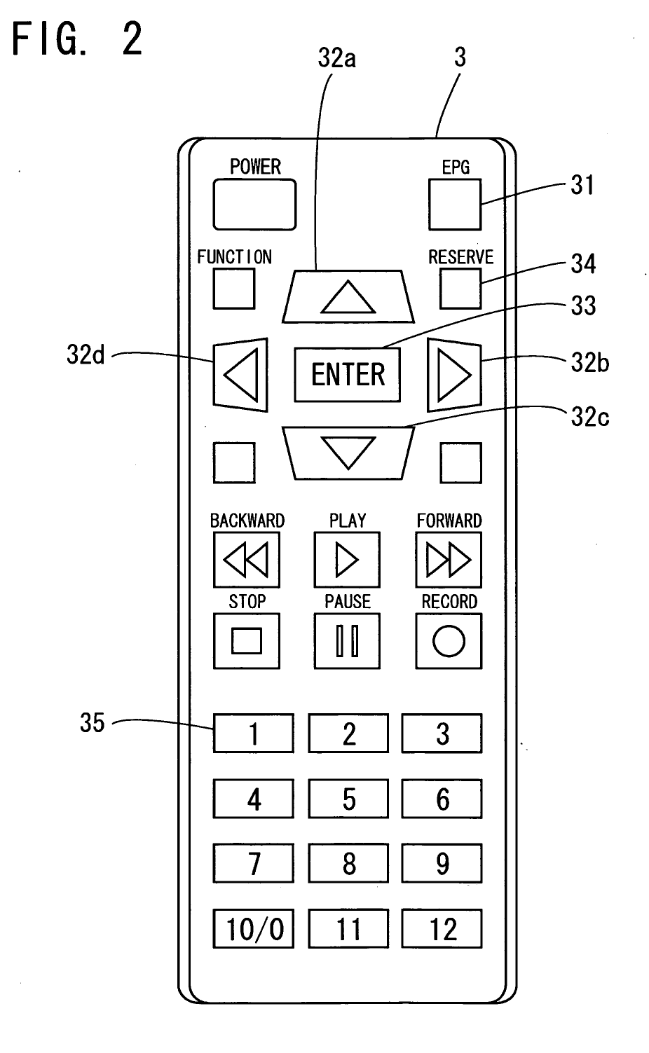

FIG. 2 shows the remote controller 3. When an EPG button 31 is pressed, a program table is displayed. The direction button (upward direction button 32a, rightward direction button 32b, downward direction button 32c, and leftward direction button 32d) allows the cursor to move in the direction in which it is pressed or allows a selected part to be moved. Pressing an “Enter” button 33 confirms an item or state selected at that time.

According to this embodiment, the reception section 10, separation section 11 and EPG decoding section 12 realize an electronic program guide information receiving function for receiving the electronic program guide information. Furthermore, the remote controller 3 and remote control light receiving section 15 realize an input function for inputting reservation information which specifies a program to be reserved. Furthermore, the RAM 13 realizes a storage function for storing electronic program guide information and reservation information. Furthermore, the video processing section 18 realizes a video processing function for outputting a video signal. Furthermore, the control section 14 realizes a control function.

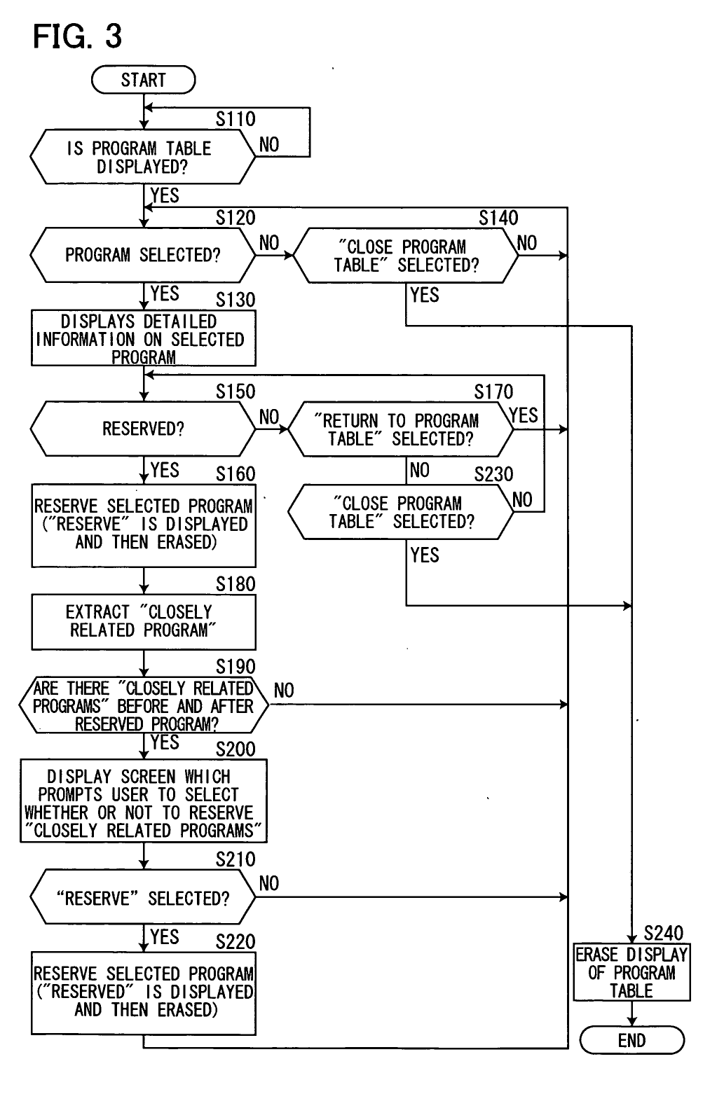

FIG. 3 is a flow chart showing a processing flow of this embodiment. When power to the receiver is turned on, the processing shown in this flow chart starts. The control section 14 controls the flow of this processing.

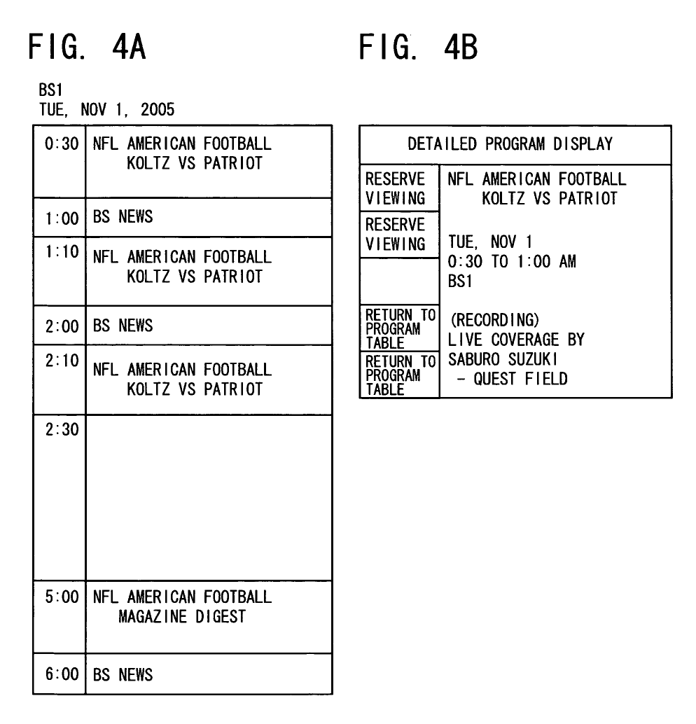

In step S110, the control section 14 judges whether or not a program table (an example is shown in FIG. 4A) is displayed. When the EPG button 31 of the remote controller 3 is pressed and the program table is displayed, the control section 14 moves to step S120 or moves to step S110 otherwise.

In step S120, the control section 14 judges whether or not a program has been selected. When programs are moved by pressing the direction button and a program is selected by the Enter button 33, the control section 14 moves to step S130 or moves to step S140 otherwise.

In step S130, the control section 14 displays detailed information (shown in FIG. 4B) on the program selected by the OSD processing section 17 and video processing section 18 and moves to step S150.

In step S150, the control section 14 judges whether or not a reservation has been set. When “Reserve viewing” or “Reserve recording” is selected out of selection items “Reserve viewing”, “Reserve recording”, “Return to program table”, “Close program table” on the left side of FIG. 4B by moving the item using the direction button and pressing the Enter button 33, the control section 14 moves to step S160 or moves to step S170 otherwise.

Instep S160, the control section 14 reserves the selected program, erases a display “Reserved” and moves to step S180. Here, the information on the selected program is stored in the RAM 13 and “Reserved” is displayed by the OSD processing section 17 and video processing section 18 in a short time.

In step S180, the control section 14 extracts programs closely related to the reserved program from among the electronic program guide information stored in the RAM 13 and moves to step S190.

In step S190, the control section 14 judges whether or not there is a program closely related to the reserved program before and after the reserved program and when there is such a program, the control section 14 moves to step S200 or moves to step S120 otherwise.

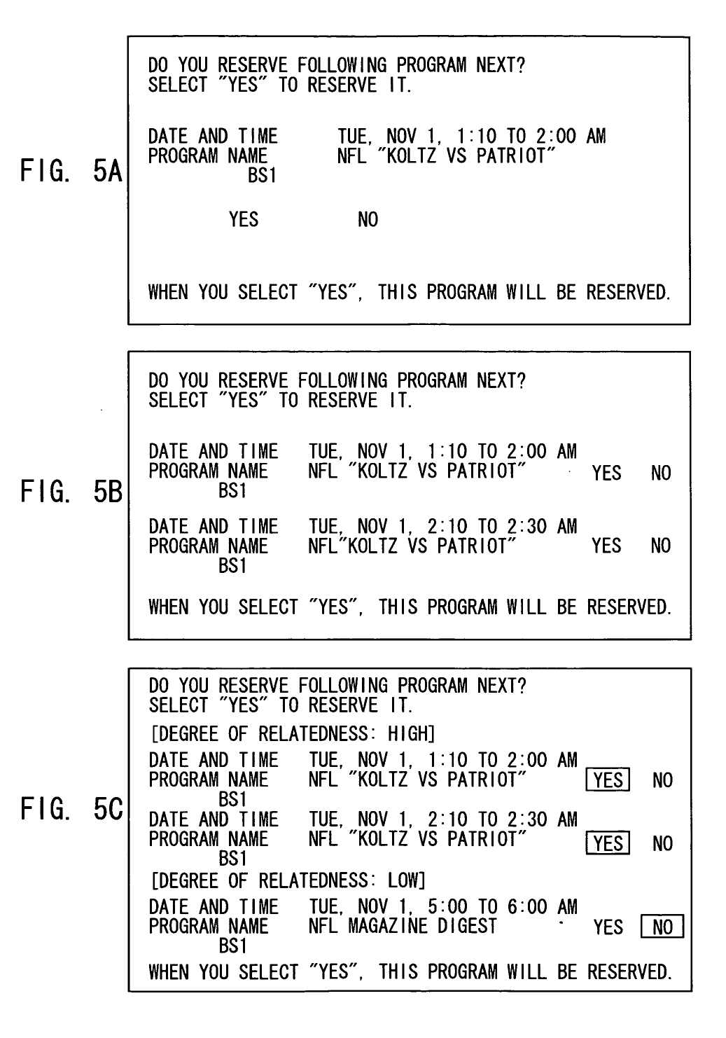

In step S200, the control section 14 displays a screen (shown in FIG. 5A or FIG. 5B) which prompts the user to select whether or not to reserve a program closely related to the reserved program using the OSD processing section 17 and video processing section 18 and moves to step S210. Here, FIG. 5A shows a screen example when the number of closely related programs is one and FIG. 5B shows a screen example when the number of closely related programs is two and on both screens, a selected part is moved using the direction button and a reservation is set by confirming it using the Enter button 33.

In step S210, the control section 14 judges whether or not “Reserve” has been selected and if “Reserve” has been selected, the control section 14 moves to step S220 or moves to step S120 otherwise.

In step S220, the control section 14 reserves the selected program, erases the display of “Reserved” and then moves to step S120. Here, the information on the selected program is stored in the RAM 13, and the OSD processing section 17 and video processing section 18 display “Reserved” for a short time.

In step S140, the control section 14 judges whether or not “Close program table” has been selected and if “Close program table” has been selected, the control section 14 moves to step S240 or moves to step S120 otherwise.

In step S170, the control section 14 judges whether or not “Return to program table” has been selected and if “Return to program table” has been selected, it moves to step S120 or moves to step S230 otherwise.

In step S230, the control section 14 judges whether or not “Close program table” has been selected and if “Close program table” has been selected, it moves to step S240 or moves to step S150 otherwise.

In step S240, the control section 14 erases the display of the program table and moves to “End.”

Here, the extraction of a closely related program can be realized by extracting a program having the name identical, program whose program name contains first three characters identical or program whose program name includes words identical to those of the reserved program within a range a predetermined number of programs before and after the reserved program.

As described above, according to the present invention, programs closely related to a program to be reserved specified by the inputted reservation information are automatically displayed, it is possible to provide a receiver provided with an electronic program guide which can easily reserve these programs. Furthermore, in the case of a program configuration whereby other programs are inserted in the middle, it is possible to provide a receiver provided with an electronic program guide which can easily reserve a necessary program excluding the programs inserted in the middle.

Note that to extract programs closely related, only programs having a broadcasting station identical to that of the reserved program may be displayed or only programs of the same genre may be displayed or only programs of the same broadcasting format (stereo broadcasting, bilingual broadcasting, captioned broadcasting, dubbed broadcasting, video multiplex telecasting, data broadcasting, bidirectional broadcasting or the like) may be displayed.

Furthermore, closely related programs may also be extracted by extracting programs including displays which suggests continuous programs (“Part 1”, “Part 2”, “First half”, “Second half”, “Prequel”, “Sequel”, “Story 1”, “(1)”, “(2)”, “⅕”, “⅖”, “Final episode” or the like).

Furthermore, closely related programs may also be extracted by extracting programs having the same broadcasting time (15-minute program, 30-minute program or the like) or programs including the same performers as those of the reserved program.

Furthermore, when closely related programs are displayed, it is also possible to display the degree of relatedness together as shown in FIG. 5C.

The effects of the present invention are as follows.

According to the present invention, programs closely related to the program to be reserved specified with the inputted reservation information are displayed automatically, and therefore it is possible to provide a receiver with an electronic program guide which can easily reserve these programs. Moreover, in the case of a program configuration where other programs are inserted in the middle thereof, it is possible to provide a receiver provided with an electronic program guide which easily reserves necessary programs in the form excluding the programs inserted in the middle thereof.

What is claimed is:

1. A receiver provided with an electronic program guide, comprising:
an electronic program guide information receiving function of receiving electronic program guide information which has a program name, broadcasting time and program explanations;
an inputting function of inputting reservation information which specifies a program to be reserved;
a storage function of storing the electronic program guide information and reservation information;
a video processing function of outputting a video signal; and
a control function of controlling the electronic program guide information receiving function, inputting function, storage function and video processing function,
wherein the control function causes the video processing function to output the video signal of the electronic program guide information stored by the storage function, and causes, when the reservation information which specifies the program to be reserved is inputted by the inputting function, the storage function to store the reservation information,
the control function searches, when the reservation information is inputted by the inputting function, programs closely related to the program to be reserved specified by the inputted reservation information from the electronic program guide information stored in the storage means, causes, when closely related programs are found within a range a predetermined number of programs before and after the program to be reserved specified with the inputted reservation information, the video processing function to output the video signal of the information which specifies the closely related programs and causes, when the reservation information which specifies the closely related programs is inputted by the inputting function, the storage function to store the reservation information of the closely related programs.

2. The receiver provided with an electronic program guide according to claim 1, wherein programs having program explanations identical or similar to those of the program to be reserved specified with the inputted reservation information are defined as closely related programs.

3. The receiver provided with an electronic program guide according to claim 1, wherein programs having program names identical or similar to that of the program to be reserved specified with the inputted reservation information are defined as closely related programs.

4. The receiver provided with an electronic program guide according to claim 1, wherein programs having an identical transmitting broadcasting station of the programs having program names identical or similar to that of the program to be reserved specified with the inputted reservation information are defined as closely related programs.
